(19) United States
(12) Patent Application Publication
(10) Pub. No.: US 2017/0291343 A1
(43) Pub. Date: Oct. 12, 2017

(54) MOLDING SYSTEM

(71) Applicant: FANUC CORPORATION, Yamanashi (JP)

(72) Inventor: Tatsuhiro UCHIYAMA, Yamanashi (JP)

(21) Appl. No.: 15/477,682

(22) Filed: Apr. 3, 2017

(30) Foreign Application Priority Data
Apr. 7, 2016 (JP) 2016-077132

(51) Int. Cl. B29C 45/76; G01N 21/88; B29C 45/03

(52) U.S. Cl. CPC B29C 45/768; B29C 45/7686; B29C 45/03; G01N 21/88; B29C 45/76; B29C 45/17

(57) ABSTRACT

A molding system capable of detecting an abnormality for each cavity when a plurality of molded articles is molded at a time by a mold having a plurality of cavities mounted on an injection molding machine is a molding system for detecting an abnormality of a cavity by inspecting a molded article molded by a mold having a plurality of cavities mounted on an injection molding machine. The molding system includes a molded article information acquiring unit for acquiring molded article information indicating a state of the molded article for each cavity over a plurality of molding cycles, and a cavity abnormality detecting unit for detecting an abnormal cavity by mutually comparing tendencies of the molded article information between cavities.

### BACKGROUND OF THE INVENTION

### 1. Field of the Invention

The present invention relates to a molding system, and more particularly to a molding system capable of detecting an abnormality for each cavity when a plurality of molded articles is molded at a time by a mold having a plurality of cavities mounted on an injection molding machine.

### 2. Description of the Related Art

A method of indirectly monitoring a quality of a molded article by monitoring a physical quantity that can be obtained from an injection molding machine has been known as a method of monitoring a quality of a molded article of an injection molding machine. Incidentally, in a molding method in which a plurality of molded articles is molded at one time by a mold having a plurality of cavities, even when there is an abnormality in each cavity, an influence thereof rarely appears in the above-mentioned physical quantity. In particular, as the number of cavities increases, even when some of the cavities are abnormal, a degree at which an influence thereof is reflected in the above physical quantity becomes relatively small. Thus, it has been difficult to detect abnormalities in individual cavities using a conventional indirect monitoring scheme.

In addition, a defect generated in a molded article is caused by various factors besides the above-mentioned cavities. For example, the defect is caused by temperature and deformation of the entire mold, resin, stability of the injection molding machine, stability of a surrounding environment of the injection molding machine, etc. However, according to the conventional monitoring method, it is difficult to distinguish between abnormality caused by each cavity and abnormality due to other causes.

Here, the abnormality of the cavity is, for example, a breakage of the cavity or a phenomenon in which a flow of resin is inhibited due to resin remaining in the cavity.

As related technologies, JP 2000-025079 A and JP 2003-170434 A disclose a product collecting apparatus and a molded article discharging apparatus for separating and collecting molded articles for each cavity. JP 2013-086358 A discloses a discriminating device for directly inspecting the appearance of a molded article to determine whether the molded article is non-defective or defective. JP 08-258093 A discloses that a weight of a molded article is measured by a molded article removing apparatus taking out the molded article.

According to the techniques described in JP 2000-025079 A and JP 2003-170434 A, a molded article can be separated and collected for each cavity. However, since no unit for rapidly detecting that there is a problem due to a specific cavity has been disclosed at all, it has been difficult to rapidly take a countermeasure against a defect.

In addition, according to technologies described in JP 2013-086358 A and JP 08-258093 A, it is possible to directly inspect molded articles, and rapidly respond to a defective article by discarding the defective article when the defective article is present . However, there is no disclosure on any unit for detecting molding defects caused by individual cavities.

### SUMMARY OF THE INVENTION

The present invention has been conceived to solve such a problem, and an object of the invention is to provide a molding system capable of detecting an abnormality for each cavity when a plurality of molded article is molded at a time by a mold having a plurality of cavities mounted on an injection molding machine.

A molding system according to an embodiment of the invention is a molding system for detecting an abnormality of a cavity by inspecting a molded article molded by a mold having a plurality of cavities mounted on an injection molding machine, and the molding system includes a molded article information acquiring unit for acquiring molded article information indicating a state of the molded article for each cavity over a plurality of molding cycles, and a cavity abnormality detecting unit for detecting an abnormal cavity by mutually comparing tendencies of the molded article information between cavities.

A molding system according to another embodiment is characterized in that the molded article information is image data or a physical quantity of the molded article.

A molding system according to another embodiment is characterized in that the molded article information acquiring unit acquires the molded article information for each molding cycle and for each cavity, and the cavity abnormality detecting unit detects the abnormal cavity based on a correlation of a change pattern of the molded article information between the cavities.

A molding system according to another embodiment is characterized in that the molded article information acquiring unit acquires the molded article information for each molding cycle and for each cavity, and the cavity abnormality detecting unit determines an abnormality of the molded article based on the molded article information, and detects the abnormal cavity based on a correlation of a change pattern of a result of the determination between the cavities.

A molding system according to another embodiment is characterized in that the cavity abnormality detecting unit determines whether the molded article is defective or non-defective based on the molded article information, calculates an integrated value of the number of non-defective articles or defective articles for each cavity based on a result of the determination, and detects the abnormal cavity based on a difference in integrated value between the cavities.

According to the invention, it is possible to provide a molding system capable of detecting an abnormality for each cavity when a plurality of molded articles is molded at a time by a mold having a plurality of cavities mounted on an injection molding machine.

### BRIEF DESCRIPTION OF THE DRAWINGS

The above-described object and characteristic of the invention and other objects and characteristics will be clear from description of embodiments below with reference to accompanying drawings. In the drawings:

FIG. 1 is a diagram illustrating a configuration of a molding system 100 according to an embodiment of the invention;

FIG. 2 is a diagram illustrating an operation of a molding system 100 according to Embodiment 1;

FIG. 3 is a diagram illustrating an operation of a molding system 100 according to Embodiment 2; and

FIG. 4 is a diagram illustrating an operation of a molding system 100 according to Embodiment 3.

### DETAILED DESCRIPTION OF THE PREFERRED EMBODIMENTS

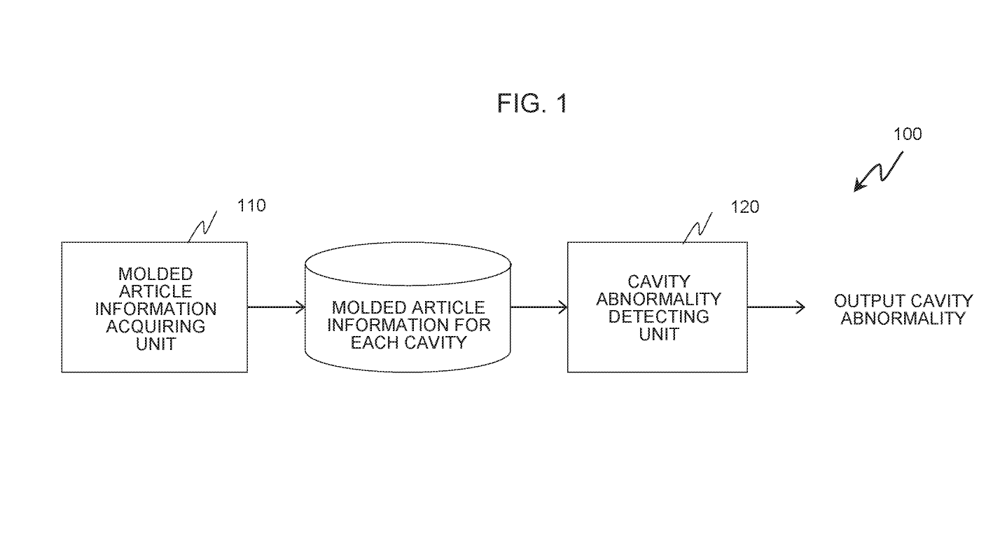

Hereinafter, specific embodiments to which the invention is applied will be described in detail with reference to drawings. FIG. 1 is a block diagram illustrating a functional configuration of a molding system 100 according to an embodiment of the invention.

The molding system 100 includes molded article information acquiring unit 110 and cavity abnormality detecting unit 120. The molded article information acquiring unit 110 and the cavity abnormality detecting unit 120 may be mounted on an injection molding machine, mounted on a peripheral device of the injection molding machine such as an extracting device, or mounted as a function of a centralized management device for the injection molding machine.

The molded article information acquiring unit 110 acquires molded article information of a molded article molded by a mold having a plurality of cavities mounted on the injection molding machine. The molded article information is information indicating a state of the molded article, typically, physical values such as a size and weight of the molded article, image data of the molded article, etc. The molded article information acquiring unit 110 includes, for example, an optical measuring device, etc., and can measure the dimensions of the molded article. Alternatively, the molded article information acquiring unit 110 includes a weighing scale, etc., and can measure a weight of the molded article. Alternatively, the molded article information acquiring unit 110 includes a camera, etc., and can capture image data.

The molded article information acquiring unit 110 acquires molded article information for each molding cycle of the injection molding machine.

In each molding cycle, molded article information is acquired for each cavity. That is, the molded article information acquiring unit 110 identifies a molding cycle and a cavity in which a molded article is molded. In order to identify a correspondence between the molded article and the cavity, for example, when the molded article can be collected while a positional relation with the cavity on the mold is maintained in a state in which the mold is pushed out from the molded article, a cavity corresponding to each molded article may be identified based on the positional relation. In addition, when identification information with respect to a cavity number is present on the molded article, each molded article and the cavity may be associated with each other by acquiring identification information using a camera and a known image processing apparatus.

The cavity abnormality detecting unit 120 performs a process of analyzing a mutual relation of molded article information between cavities and detecting an abnormality of each cavity based on an analysis result. Further, when an abnormality of the cavity is detected, the cavity abnormality detecting unit 120 may output a detection result to the injection molding machine to suspend a molding operation, or operate an output device such as a warning lamp to inform an operator in a factory. In addition, information for specifying the cavity from which the abnormality is detected may be output by screen display, sound, etc. In this way, it is possible to take a rapid countermeasure against a molding defect caused by the cavity.

### Embodiment 1

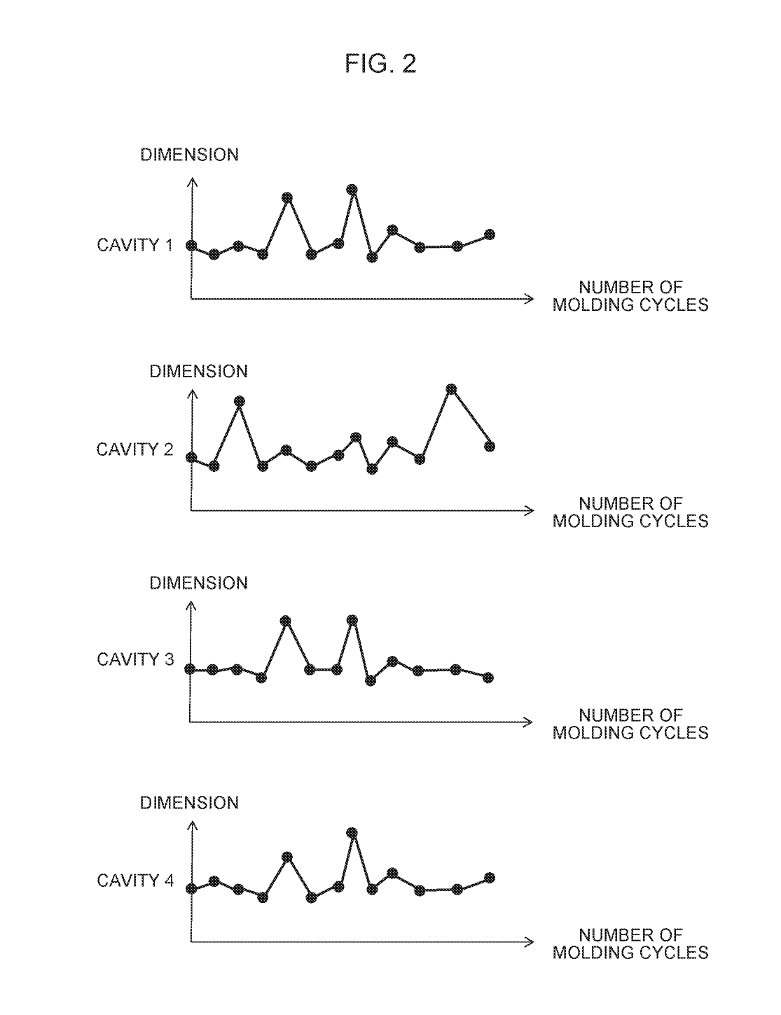

An operation of the molding system 100 according to Embodiment 1 will be described with reference to FIG. 2.

First, the molded article information acquiring unit 110 acquires and stores molded article information, for example, a physical quantity of the molded article for each molding cycle and for each cavity over a plurality of molding cycles. FIG. 2 is a graph illustrating a transition (change pattern) of a dimension for each cavity when the molded article information acquiring unit 110 acquires the dimension of the molded article over a plurality of molding cycles.

Subsequently, the cavity abnormality detecting unit 120 obtains a correlation between cavities in the change pattern of the physical quantity of the molded article. Then, a cavity having a lowest correlation with other cavities is detected as an abnormal cavity.

In general, in the same molding cycle, all cavities are molded under the same conditions except for those caused by the cavities. Therefore, when there is no abnormality due to a cavity, the change pattern of the physical quantity of the molded article over a plurality of molding cycles is presumed to indicate the same tendency in all the cavities. Here, when there is a cavity having a change pattern which has a different tendency from that of other cavities, abnormality is suspected in the cavity. In the present embodiment, it is determined that a probability of abnormality is high with respect to a cavity indicating a most different tendency among the cavities.

Typically, the cavity abnormality detecting unit 120 can specify a cavity with which a change pattern of a physical quantity of a molded article indicates a different tendency from that of other cavities as an abnormal cavity using a known method such as principal component analysis. Alternatively, the cavity abnormality detecting unit 120 calculates a correlation coefficient of a change pattern of a physical quantity of a molded article between a certain cavity and another cavity in a round robin, that is, for all possible combinations of cavities. Then, a cavity with which an average value of correlation coefficients with respect to other respective cavities is closest to 0 can be specified as an abnormal cavity.

In an example of FIG. 2, it may be determined that a change pattern of a dimension of cavity 2 has a different tendency from that of the other cavities. Finally, when an abnormality of a cavity is detected, the cavity abnormality detecting unit 120 outputs a detection result.

### Embodiment 2

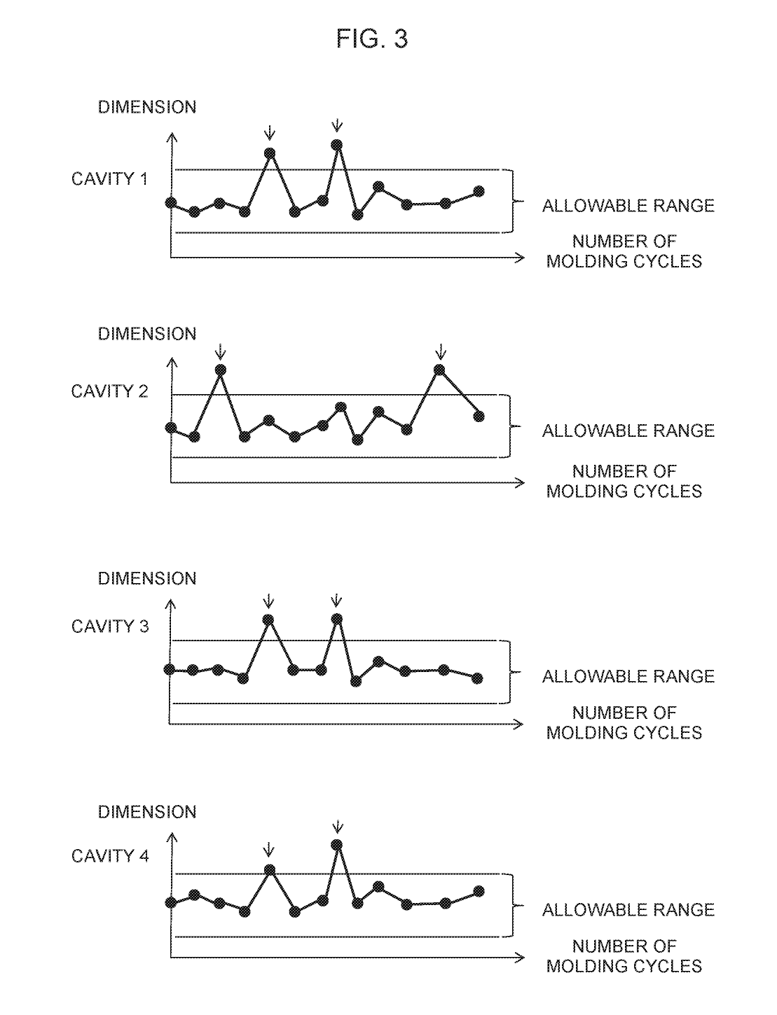

An operation of the molding system 100 according to Embodiment 2 will be described with reference to FIG. 3.

First, similarly to Embodiment 1, the molded article information acquiring unit 110 acquires and stores molded article information for each molding cycle and for each cavity over a plurality of molding cycles. FIG. 3 is a graph illustrating a transition (change pattern) of a dimension for each cavity when the molded article information acquiring unit 110 acquires a dimension of a molded article over a plurality of molding cycles.

Subsequently, the cavity abnormality detecting unit 120 determines whether the molded article is a non-defective or defective article based on the molded article information of each cavity for each molding cycle. For example, when the molded article information is a physical quantity, it is determined whether the acquired physical quantity is within a predetermined allowable range. The molded article is a non-defective article when the physical quantity is within the permissible range, and the molded article is a defective article when the physical quantity is not within the permissible range. When the molded article information is image data, for example, it is possible to determine whether the molded article is a non-defective article or a defective article based on a difference between reference image data held in advance and acquired image data. The molded article is a non-defective article when the number of differences is within a predetermined range, and the molded article is a defective article when the number of differences is not within the predetermined range.

Then, the cavity abnormality detecting unit 120 obtains a correlation of an occurrence pattern of a non-defective article or a defective article between cavities, and detects a cavity having a lowest correlation with other cavities as an abnormal cavity.

For example, in each molding cycle, the cavity abnormality detecting unit 120 aggregates the number of cavities in which molded articles are non-defective articles and the number of cavities in which molded articles defective articles, and compares the numbers. Then, the cavity abnormality detecting unit 120 determines whether each cavity belongs to majority or minority. The cavity abnormality detecting unit 120 successively executes this determination over a plurality of molding cycles, and then identifies a cavity with the largest number of times classified as minority as an abnormal cavity.

In an example of FIG. 3, it is determined that cavity 2 is abnormal since cavity 2 has a different tendency in defect generation pattern from that of other cavities. Finally, when an abnormality of a cavity is detected, the cavity abnormality detecting unit 120 outputs a detection result.

### Embodiment 3

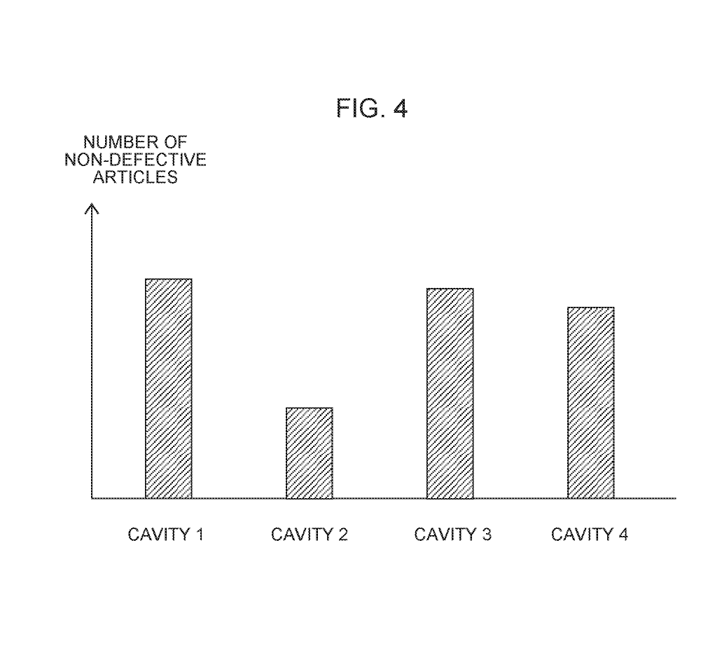

An operation of the molding system 100 according to Embodiment 3 will be described with reference to FIG. 4.

First, similarly to Embodiment 2, the molded article information acquiring unit 110 acquires and stores molded article information for each molding cycle and for each cavity over a plurality of molding cycles. Then, the cavity abnormality detecting unit 120 determines whether a molded article of each cavity is a non-defective article or a defective article for each molding cycle.

The cavity abnormality detecting unit 120 accumulates the number of non-defective molded articles and the number of defective molded articles for each cavity over a plurality of molding cycles. Then, when a difference in integrated value of the number of non-defective articles or the number of defective articles between a certain cavity and another cavity exceeds a predetermined threshold value, a cavity with which the largest number of defective articles is molded is identified as an abnormal cavity.

FIG. 4 is a graph illustrating an integrated value of the number of non-defective articles for each cavity over a plurality of molding cycles. Here, when a difference in integrated value of the number of non-defective articles or the number of defective articles between cavities exceeds a predetermined threshold value, cavity 2, which is a cavity with which the largest number of defective articles or the smallest number of non-defective articles are molded, is determined to be abnormal. Finally, when an abnormality of a cavity is detected, the cavity abnormality detecting unit 120 outputs a detection result.

According to the present embodiment, the molded article information acquiring unit 110 successively acquires molded article information for each molding cycle and for each cavity, and the cavity abnormality detecting unit 120 compares the molded article information between the cavities, thereby detecting an abnormality of a cavity. For this reason, it is possible to rapidly detect an abnormality for each cavity. In addition, since a correlation of molded article information between cavities can be identified, it is possible to formulate an appropriate abnormality countermeasure based on the identified information.

The invention is not limited to the above-described various embodiments, and it is possible to make a change such as replacement, omission, addition, order change, etc. of constituent elements without departing from the spirit.

For example, in the above-described embodiment, the molded article information acquiring unit 110 acquires molded article information while identifying a molding cycle and a cavity in which a molded article is molded. However, in Embodiment 3, the molded article information acquiring unit 110 may not identify each molding cycle when molded article information can be obtained over a plurality of cycles.

Although the embodiments of the invention have been described above, the invention is not limited to examples of the above-described embodiments, and can be implemented in other modes by making appropriate changes.

1. A molding system for detecting an abnormality of a cavity by inspecting a molded article molded by a mold having a plurality of cavities mounted on an injection molding machine, the molding system comprising:
a molded article information acquiring unit for acquiring molded article information indicating a state of the molded article for each cavity over a plurality of molding cycles; and
a cavity abnormality detecting unit for detecting an abnormal cavity by mutually comparing tendencies of the molded article information between cavities.

2. The molding system according to claim 1, wherein the molded article information is image data or a physical quantity of the molded article.

3. The molding system according to claim 1,
wherein the molded article information acquiring unit acquires the molded article information for each molding cycle and for each cavity, and
the cavity abnormality detecting unit detects the abnormal cavity based on a correlation of a change pattern of the molded article information between the cavities.

4. The molding system according to claim 1,
wherein the molded article information acquiring unit acquires the molded article information for each molding cycle and for each cavity, and
the cavity abnormality detecting unit determines an abnormality of the molded article based on the molded article information, and detects the abnormal cavity based on a correlation of a change pattern of a result of the determination between the cavities.

5. The molding system according to claim 1, wherein the cavity abnormality detecting unit determines whether the molded article is defective or non-defective based on the molded article information, calculates an integrated value of the number of non-defective articles or defective articles for each cavity based on a result of the determination, and detects the abnormal cavity based on a difference in integrated value between the cavities.
